(19) United States
(12) Patent Application Publication
(10) Pub. No.: US 2007/0257511 A1
(43) Pub. Date: Nov. 8, 2007

(54) Slideout room with movable/removable endwalls and/or retractable ceiling

(76) Inventor: Catherine E. Dickenson, St. Francis, MN (US)

Correspondence Address: John S. Munday, Esquire, PO Box 423, Isanti, MN, 55040, US

(21) Appl. No.: 11/490,006

(22) Filed: Jul. 20, 2006

Related U.S. Application Data
(60) Provisional application No. 60/798,884, filed on May 8, 2006.

(51) Int. Cl. B60P 3/39

(52) U.S. Cl. 296/165

(57) ABSTRACT

A slide out room for use with vehicles and other structures that use such slide out rooms to expand the interior usable space when stationary and retract such slide out rooms during travel or storage. The slide out room includes a floor, roof, main side wall and a pair of end walls, forming a room within a room. The entire assembly is movable from an extended position to a retracted position as desired. Portions of the end walls of the present invention are removable or retractable when the slide out room is retracted into the vehicle or other structure, so that the space occupied by the end walls is open, both visibly and physically, to provide greater utility for the room when retracted in without affecting its use when extended out.

### FIELD OF THE INVENTION

The present invention relates to slide out room assemblies for vehicles such as motor homes, recreational vehicle trailers, mobile command units and the like. More particularly, the invention relates to improvements in the slide out room assemblies that provide for significantly improved visibility for drivers and passengers during the operation of these vehicles.

### BACKGROUND OF THE INVENTION

There are a number of different vehicles that use what is universally known in the industry as slideout rooms, which are slidable room assemblies affixed to one side or both sides or the rear another of a vehicle. Most motor homes, recreational vehicle trailers have slide out rooms, as do mobile command units and swat vehicles. The present invention in intended for use with any vehicle or building that employs one or more slide out rooms.

When the vehicle is parked, the room is extended out or slides out to give additional living space, storage space, work space and the like. When the vehicle is in motion, the slide out rooms are retracted in, normally to a position which gives the vehicle at least the width needed to be operated legally. Often the slide out rooms retract to be flush with the remaining exterior portion of that side of the vehicle.

The manufacturers of these vehicles and trailers have been restricted as to the overall size of these vehicles by various governmental agencies and legislative acts that define very rigidly the maximum lengths and widths that these vehicles can occupy. Existing slide out room technology has been able to significantly increase the amount of usable space, in terms of square footage defined within these vehicles. However, the existing designs and methods of manufacture have certain undesirable qualities that are inherent with the current designs and techniques in use today.

Movable slide out rooms usually include a floor, a roof, a main side wall on the outside, and two end walls, forming a room within a room. In the retracted position, the roof, both end walls and the floor are concealed from exterior view inside of the main body of the vehicle while the slide out's main sidewall forms a portion of the vehicle's exterior side wall and is sealed from the elements. The floor of the slide out room typically rests on or above the main floor of the vehicle, which remains fixed, and may form a portion of the usable interior floor while the vehicle is in transit. The slide out roof or ceiling may define part of the interior ceiling of the vehicle during transit, or simply slides under the existing ceiling of the vehicle. The ceiling of the existing slide out rooms, in some instances when retracted in, obstructs the field of vision of the occupants as well as reduces the usable head room inside the vehicle.

Similarly, the end walls of the slide out rooms are also stored inside the vehicle when in the retracted position, yet they serve no useful purpose inside of the vehicle except to hold up the roof. End walls create an enormous obstruction of vision and limitation of movement within and throughout the vehicle. In effect one has a three foot wide box positioned inside an eight foot wide hallway, reducing over one third of the width of the vehicle. Some manufacturers have placed a slide out room on both sides of the vehicle, thus doubling the restrictions.

While slide out rooms provide many advantages by increasing the useable space in the vehicle, there is one drawback that has not been addressed by the industry. That is the fact that when the slide out room is retracted in, to permit operation of the vehicle, the room takes up space inside the unit. Visibility for the driver or passenger is severely restricted or obscured, and movement about the vehicle by passengers is difficult at best. In some instances it isn't even practical for a co-driver to make his or her way to a resting place, or get a refreshment for the driver. This closed in space forces the driver to rely exclusively on the side view mirrors. Side view mirrors are adequate for semi-tractor trailer rigs that haul freight and other items from one location to another. It is not adequate for vehicles that function as a recreation site, office or control center, and the like, where communication between the driver and others in the vehicle is restricted.

Accordingly, it would be of advantage in the art if a device could be provided that eliminated a substantial part of the obstruction caused by the end walls when the slide out room is retracted in.

Yet another advantage would be if the obstruction could be removed without substantial effort or inconvenience.

It would be another advance in the art if the slide out room would provide more functionable useable space even when the slide out room or rooms have been retracted in.

The art would be advanced if visibility and communication between the driver and the passenger could be improved when a slide out room is retracted in.

Still another advantage would be if the occupants of a vehicle having a slide out room retracted in could have the space to move more freely in the event of an accident.

Other advantages will appear hereinafter.

### SUMMARY OF THE INVENTION

It has now been discovered that the above and other advantages of the present invention may be obtained in the following manner. Specifically, the present invention provides for removable end sections, full or partial, that are in place when the slide out room is extended for use when the vehicle is stationary, and removed or retracted when the slide out room is retracted into the vehicle for transit or parking purposes.

The present invention removes or reduces the physical and visual obstructions of the end walls when the slide out room is in the retracted position, and, further, may reduce physical and visual obstruction by the slide out room ceiling.

Various embodiments are shown below that illustrate the various ways the end walls and ceiling of the slide out room can accomplish the advantages of the present invention, to preserve the normal function of the slide out room and yet significantly adds to the usable space and functionality of the interior of the vehicle. The present invention accommodates normal manufacturing procedures without any significant loss of uniformity in the finished appearance, and maintains the same weather seal. The present invention is light weight and does not interfere with the slide out room normal functions and alignment. Besides being of low cost and easy to manufacture, it is durable and convenient to use. In some instances, existing slide out room designs on certain existing vehicles that use conventional slide out room technology, can be retrofitted with the present invention

### BRIEF DESCRIPTION OF THE DRAWINGS

For a more complete understanding of the invention, reference is hereby made to the drawings, in which:

FIG. 1 is a perspective view of a normal slide out room;

FIG. 2 is a perspective view illustrating a standard slide out room in a retracted position limiting vision and movement in the vehicle;

FIGS. 3a and 3b are perspectives view illustrating one embodiment of the present invention;

FIGS. 4a and 4b are perspective views illustrating the use of the embodiment of FIGS. 3a and 3b in a slide out room;

FIG. 5 is a perspective view illustrating the embodiment of FIGS. 4a and 4b in a vehicle ready to be in transit;

FIGS. 6a, 6b and 6c are perspectives view illustrating another embodiment of the present invention;

FIGS. 7a and 7b are perspectives view illustrating yet another embodiment of the present invention;

FIGS. 8a and 8b are perspectives view illustrating still another embodiment of the present invention;

FIGS. 9a and 9b are perspectives view illustrating the embodiment of FIGS. 8a and 8b, shown apart from the vehicle;

FIGS. 10a and 10b are perspectives view illustrating a similar embodiment of the present invention as shown in FIGS. 9a and 9b in a slide out room;

FIGS. 11a 11b and 11c are perspectives view illustrating a different embodiment of the present invention, also showing the embodiment extended from the vehicle;

FIG. 12 is a perspectives view illustrating the use of the embodiment shown in FIGS. 11a, 11b and 11c, from a perspective on the vehicle;

FIG. 13 is a perspectives view of the embodiment of the present invention shown in FIG. 12, illustrating the retracted position;

FIGS. 14a and 14b are perspectives view illustrating an additional embodiment of the present invention;.

FIG. 15 is a perspectives view illustrating the embodiment of FIGS. 14a, 14b and 14c in a vehicle, in the extended position;

FIGS. 16a and 16b are side elevational views, cut away, illustrating the embodiment in FIG. 15;

FIGS. 17a and 17b are perspectives view illustrating yet another embodiment of the present invention;

FIG. 18 is a perspectives view illustrating the embodiment in FIGS. 17a and 17b, retracted in a vehicle;

FIGS. 19a, 19b and 19c are perspectives view illustrating detailed the embodiment of FIG. 18;

FIG. 20 is perspectives view of the embodiment in FIGS. 17 and 17b, extended in a vehicle;

FIGS. 21a, 21b and 21c are perspectives view illustrating a variation on the embodiment shown in FIGS. 17a and 17b;

FIG. 22 is perspectives view illustrating the embodiment shown in FIGS. 21a and 21b in a vehicle;

FIGS. 23a, 23b and 23c are perspectives view illustrating still another variation on the embodiment shown in FIGS. 17a and 17b;

FIG. 24 is a perspectives view illustrating the use of the embodiment shown in FIGS. 23a, 23b and 23c in a vehicle;

### DETAILED DESCRIPTION OF THE PREFERRED EMBODIMENT

The present invention is shown in various embodiments described below with reference to the drawings. In all figures, like numbers represent like components.

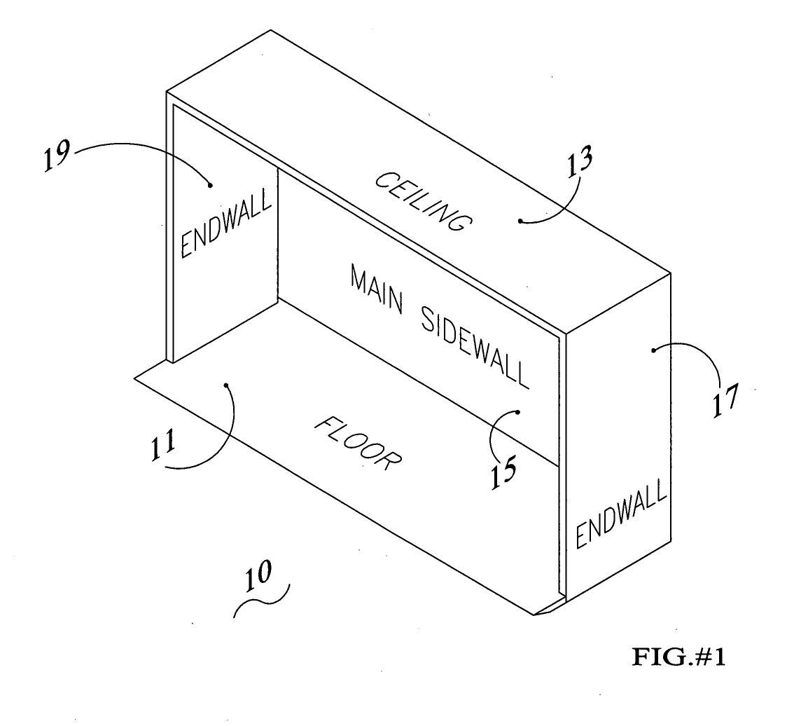

In FIG. 1, a standard slide out room, 10 generally, is shown with a floor 11, ceiling 13, main side wall 15, and first and second end walls 17 and 19. As is evident, end walls 17 and 19 are solid and would block physical and visual access when retracted into the structure.

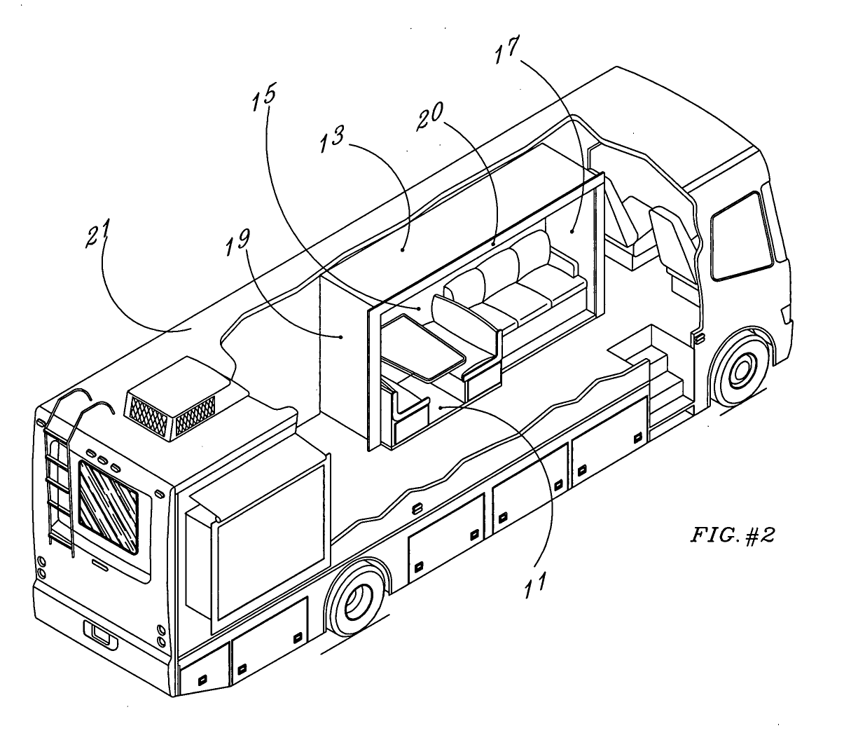

FIG. 2 illustrates the present invention in a class A motor home or RV 21. The present invention is intended for use with motor homes, travel trailers, recreational vehicle trailers, mobile medical vehicles, mobile command units and swat vehicles. The present invention is also intended for use with any vehicle or building that employs one or more slide out rooms, as, by way of one example, temporary offices at construction sites and the like. The present invention does not depend on the specific structure, whether mobile or stationary, and thus the word “structure” is intended to mean and cover all such stationary an mobile constructions including, but not limited to those listed herein.

As can be seen in FIG. 2, the slide out room 20 includes floor 11, ceiling 13, main side wall 15 and first and second end walls 17 and 19. It is evident that end walls 17 and 19 intrude into the space, and while use of the table and chairs is still possible, it is difficult to pass the end walls, and would be even more so if a second slide out room were used on the other side of the structure. It is also clear that the driver of the RV 21 does not have visual access to the back of the structure.

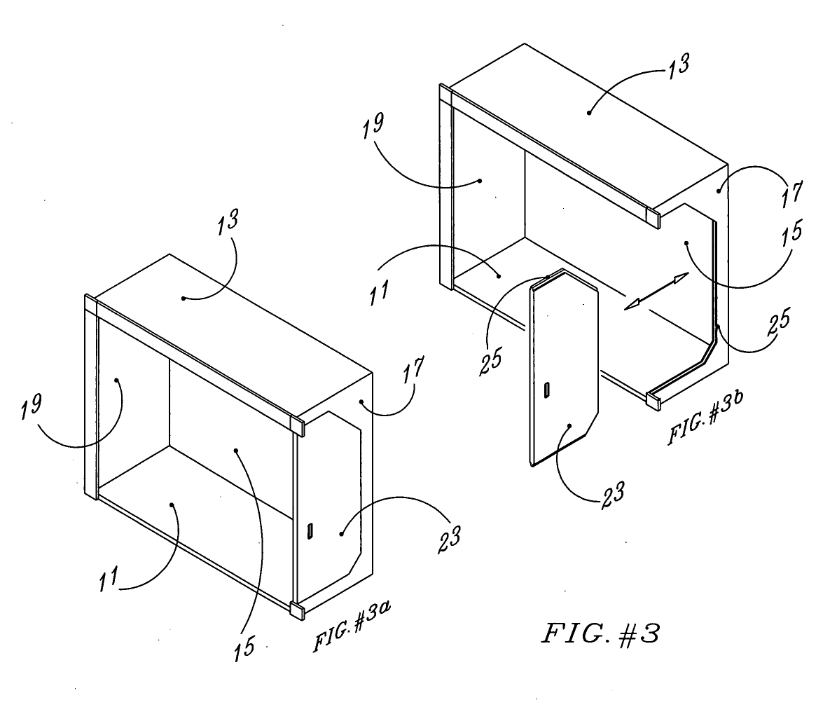

FIGS. 3a and 3b illustrate one embodiment of the present invention, in which end wall 17 includes a panel 23 that is removable, as in FIG. 3b, when the slide out room is retracted. Panel 23 includes a seal 25 that mates with end wall 17 to preserve the integrity of the room when extended, as in FIG. 3a.

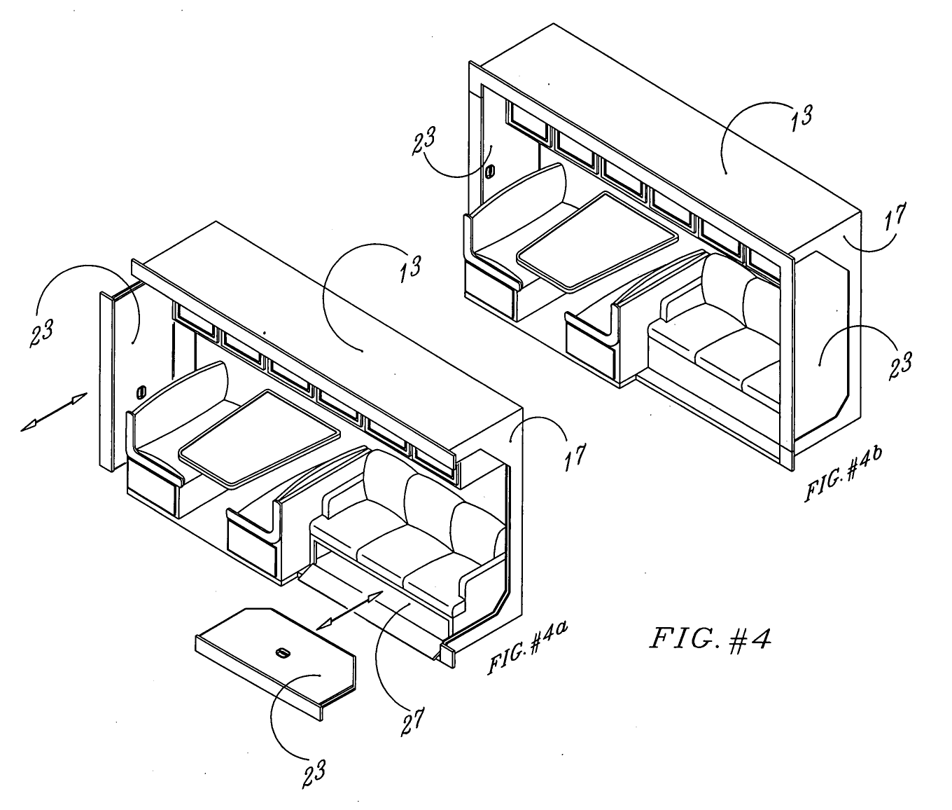

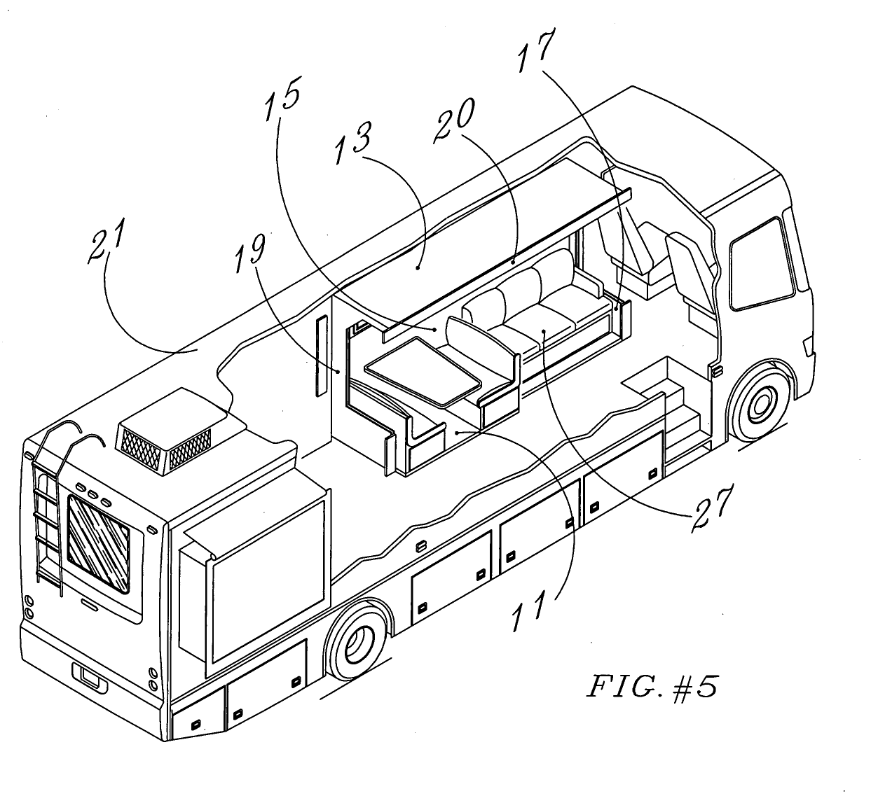

FIGS. 4a and 4b illustrate the storage of panel 23 in the space under couch 27. In FIG. 5, both end wall panels 17 and 19 have had panels 23 removed and stored, so that physical and visual access in significantly improved.

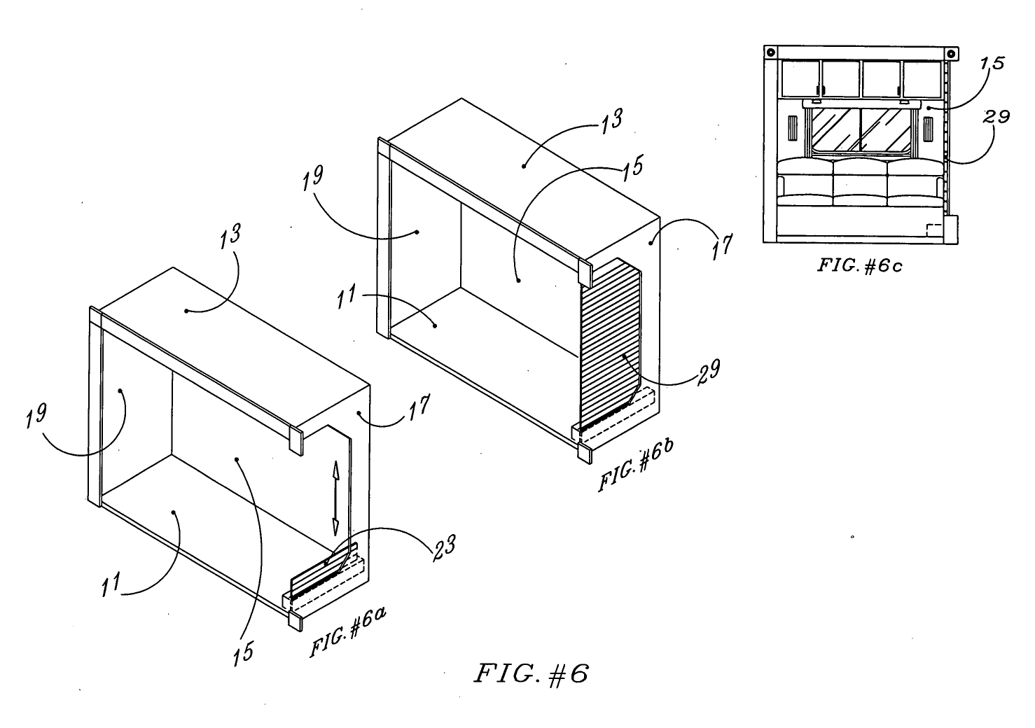

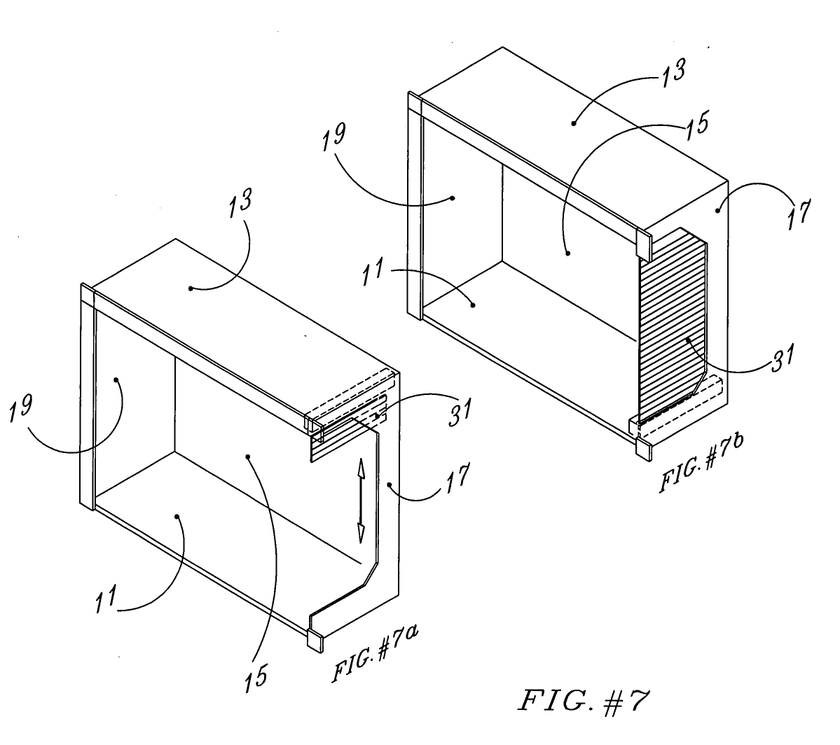

FIGS. 6a, 6b and 6c illustrate another embodiment of the present invention, in which a roll up panel 29 has been added to end wall 17, shown retracted or rolled up in FIG. 6a into the box on the floor 11, and rolled out or extended in FIG. 6b. FIG. 6c illustrates the panel from a front view of FIG. 6b. FIGS. 7a and 7b illustrate a roll up wall 31 that goes up into the box on the ceiling 13.

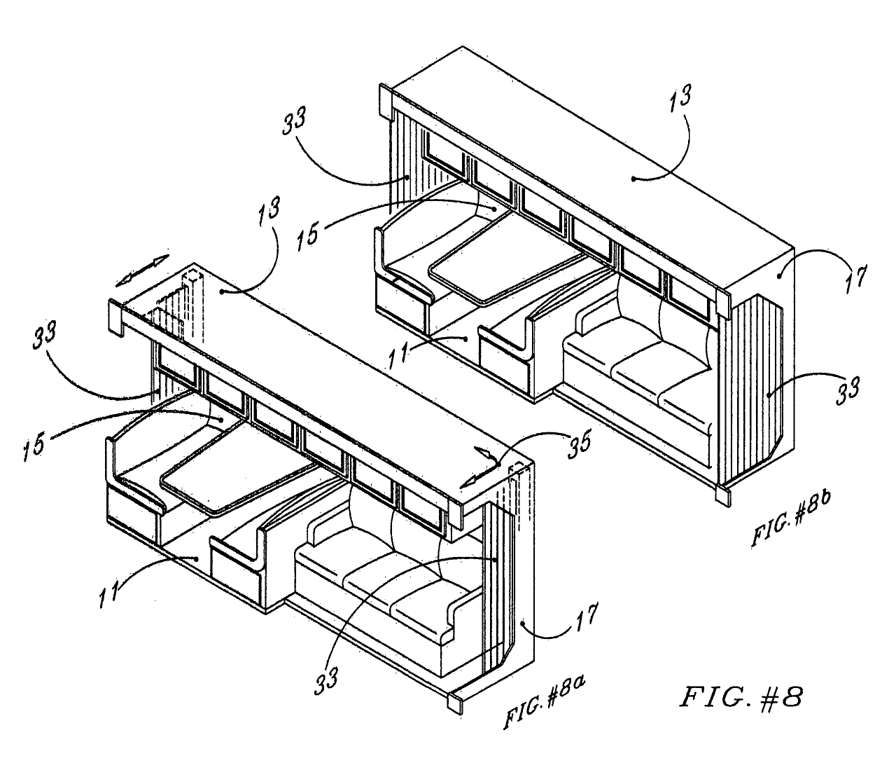

FIGS. 8a and 8b illustrate another form of roll out wall panels, where roll out panels 33 can be retracted into main side wall 15 into a compartment as shown by arrows 35 to again provide increased physical and visual openness when the slide out room is retracted.

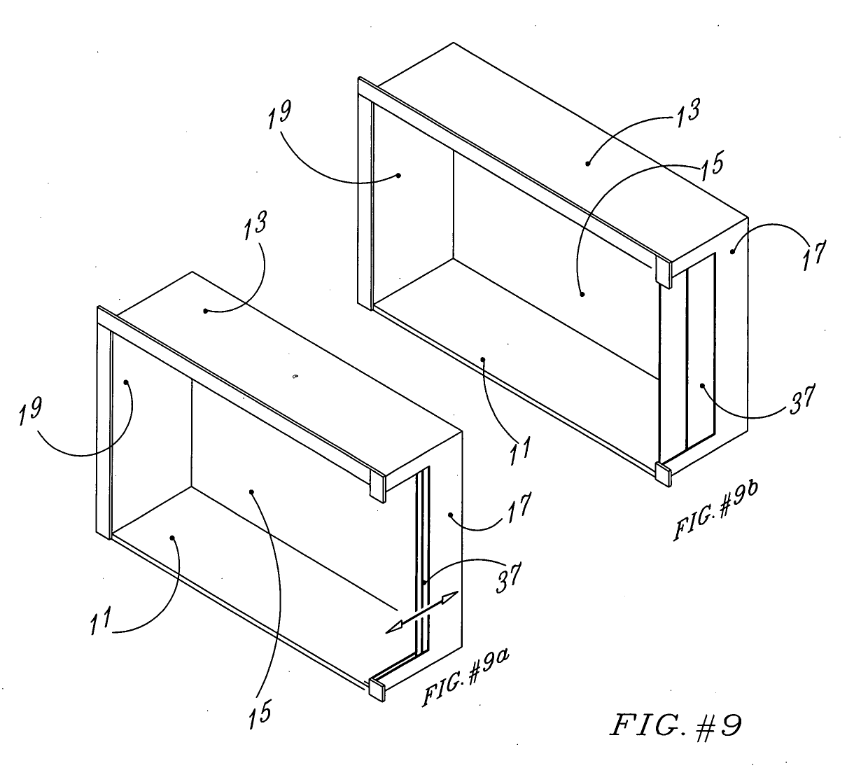

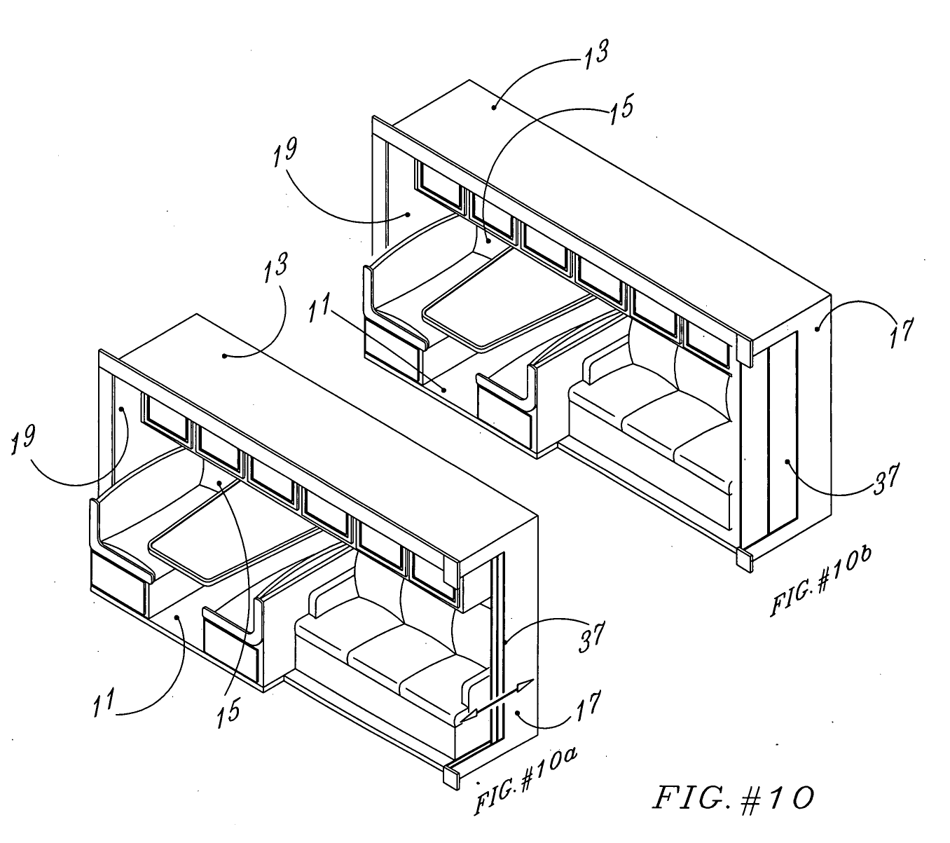

In another embodiment the panels will be formed from sliding panels as shown in FIGS. 9a and 9b, where panel 37 slides into or against end wall 17. This does not remove all of the end wall, but is a convenient design, is easy to manufacture, and gives good physical and visual access to the inside of the structure as seen in FIGS. 10a and 10b.

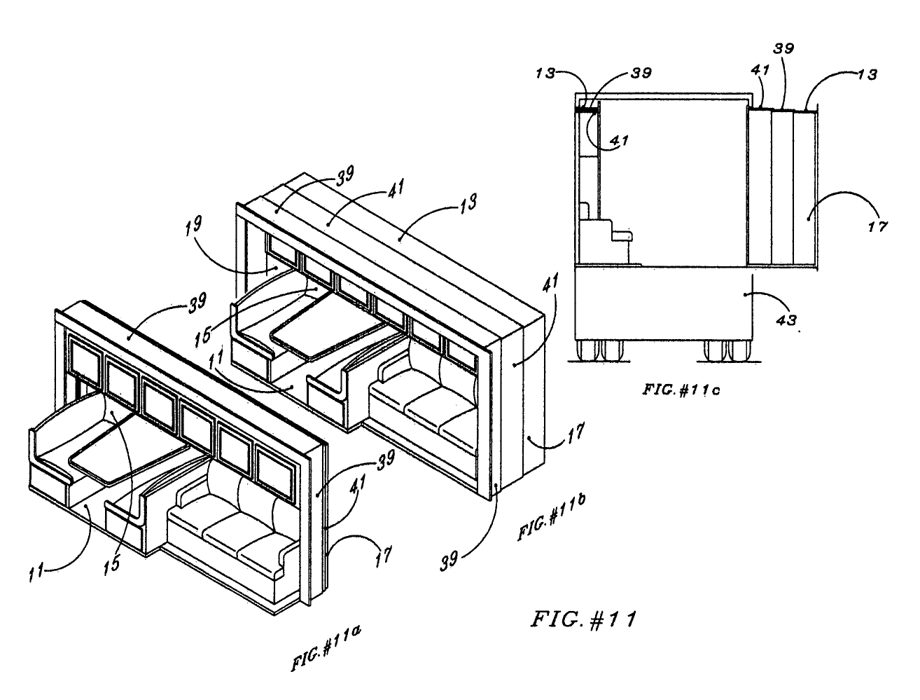

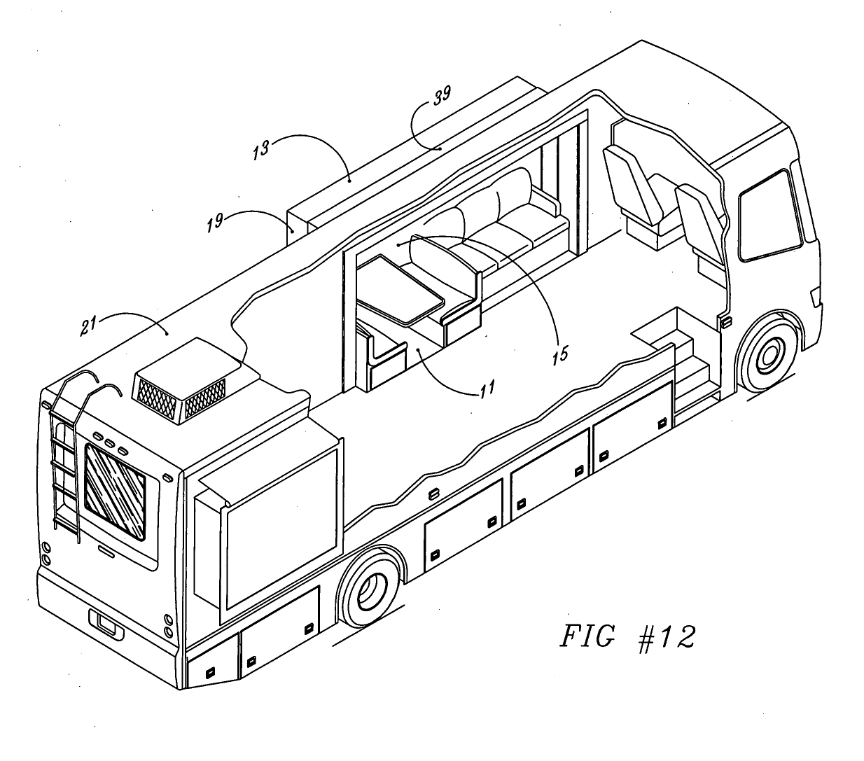

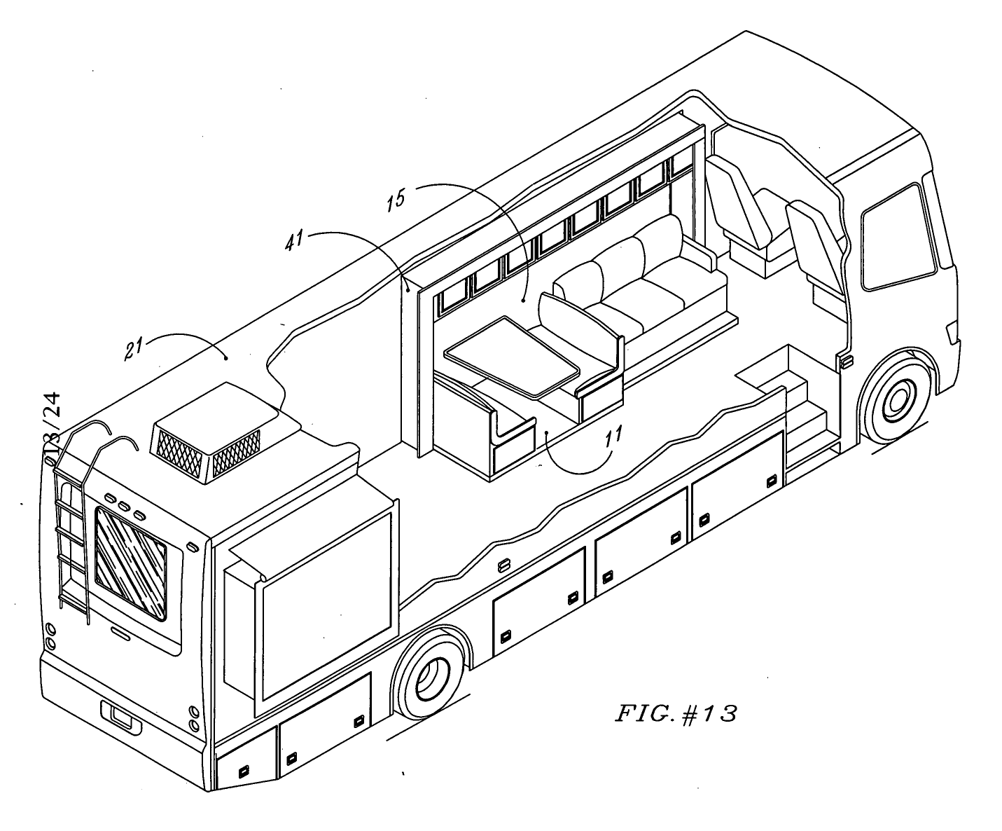

FIGS. 11a, 11b, and 11c illustrate a more elaborate sliding panel embodiment that that of FIGS. 10a and 10b, where the slide out includes a front portion 39 and a middle portion 41 that slide into ceiling 13 and end walls 17 and 19. FIG. 11c shows the back 43 of a vehicle with the left or driver's side retracted into the vehicle 43 and the curb side extended out on the right side. In FIG. 11c, it is clear that the present invention provides substantial access to the room when retracted. FIG. 12 illustrates the vehicle 43 in perspective with the slide out room extended. FIG. 13 shows the same embodiment with the slide out room retracted. Driver visibility is excellent.

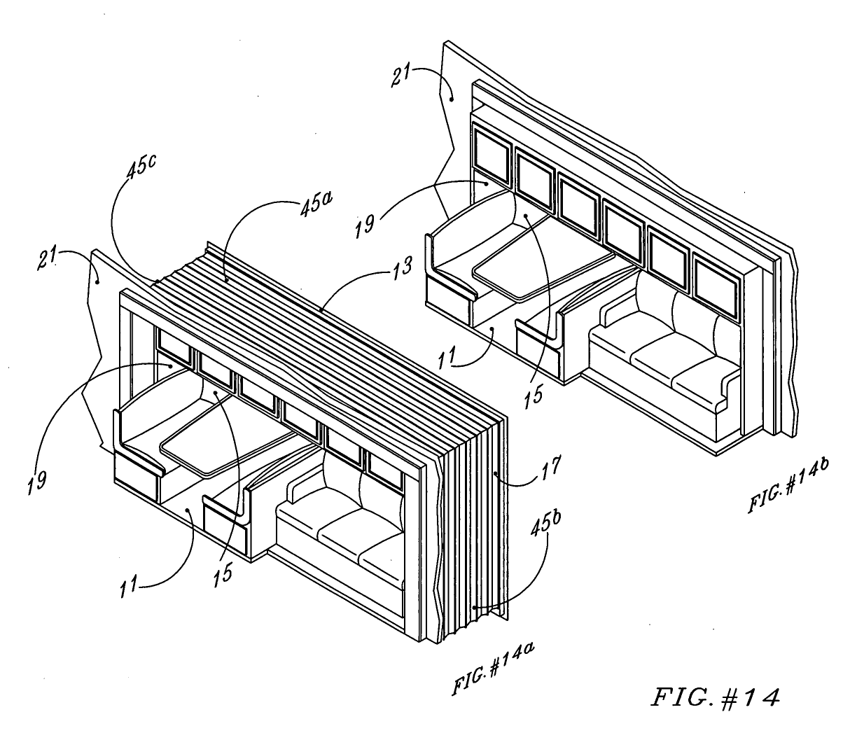

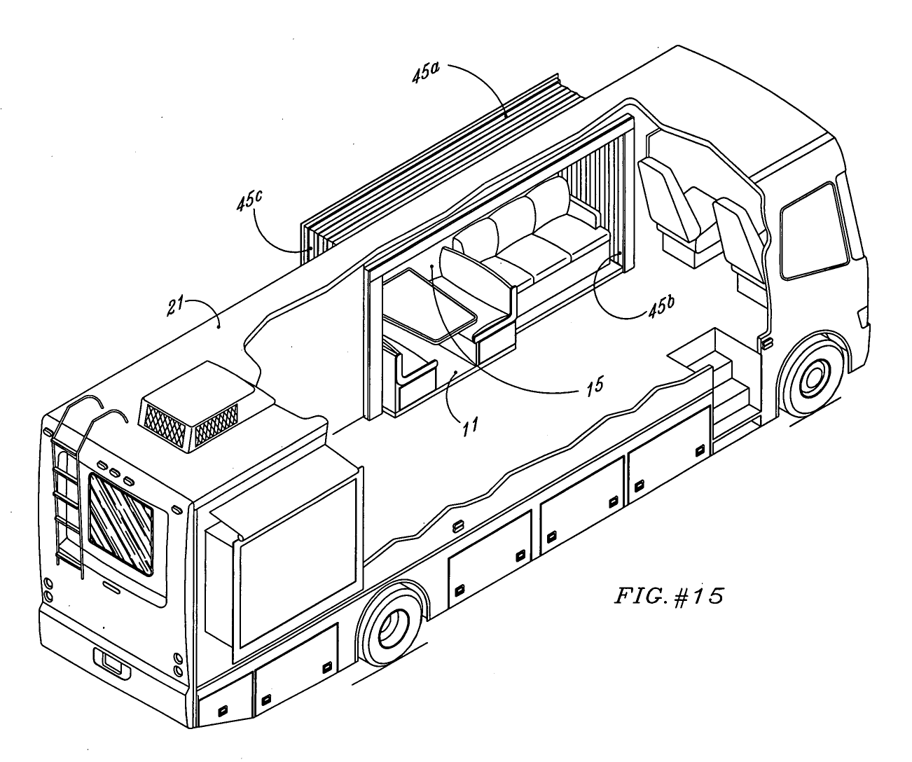

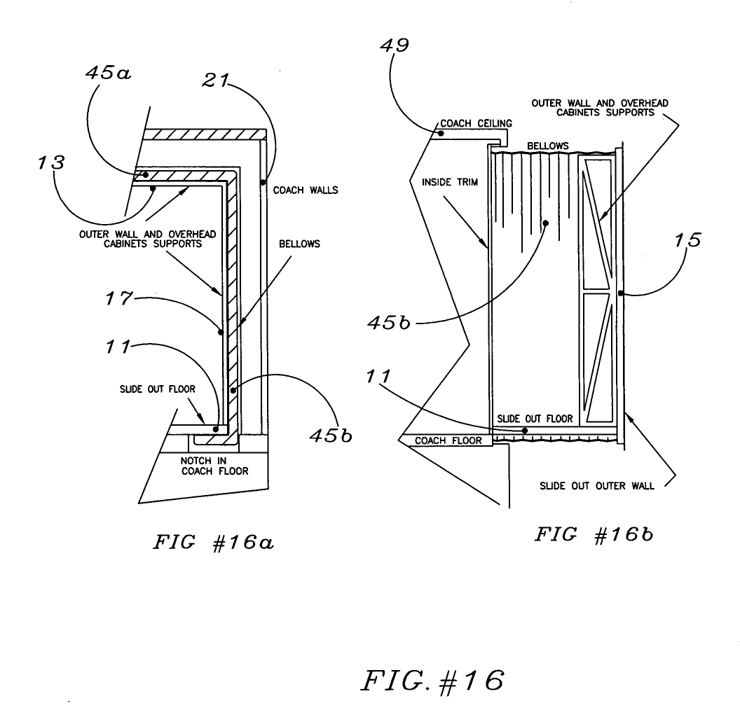

FIGS. 14a and 14b illustrate a different embodiment of the present invention in which a portion of both the ceiling 13 and end walls 17 and 19, are formed and attached to a bellows 45 that expands in FIG. 14a when the slide out room is extended and folds into them when retracted. Bellows 45 has both a ceiling portion 45a and end wall portions 45b and 45c as shown and as also illustrated in FIG. 15. In FIG. 16a, the relationship of bellows 45 and the structure is shown in relationship to the vehicle floor 47 and ceiling 49.

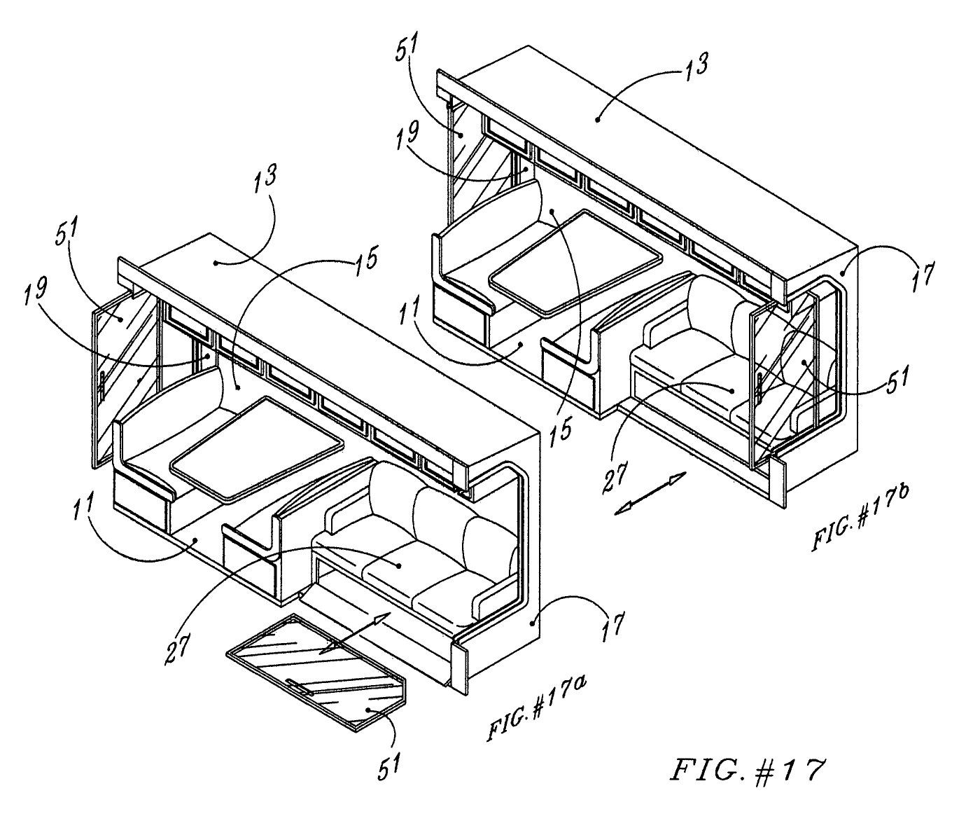

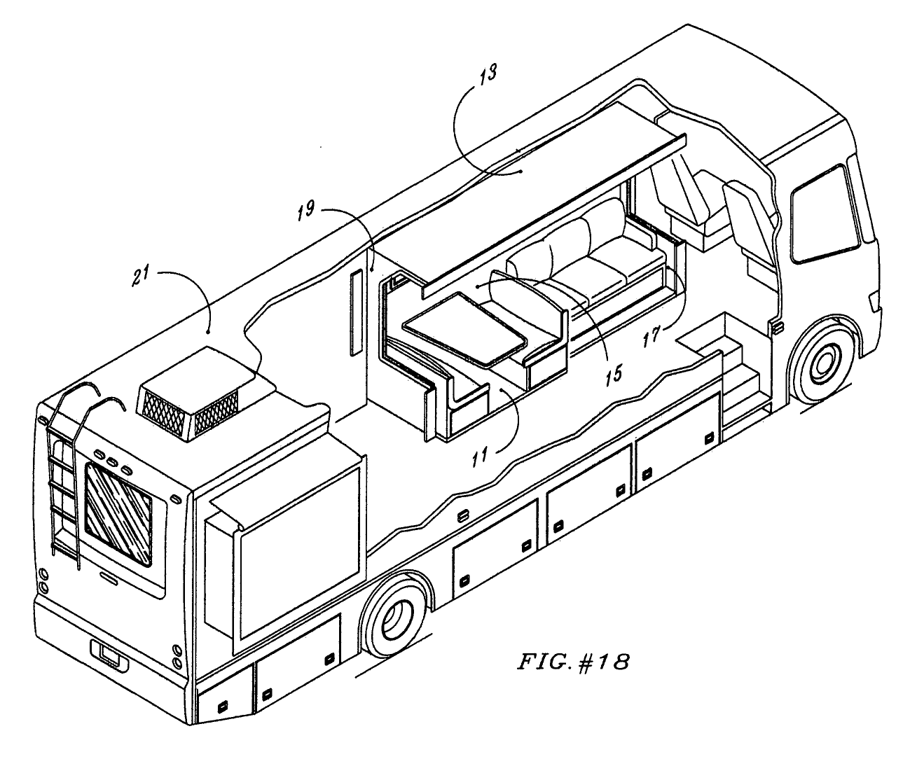

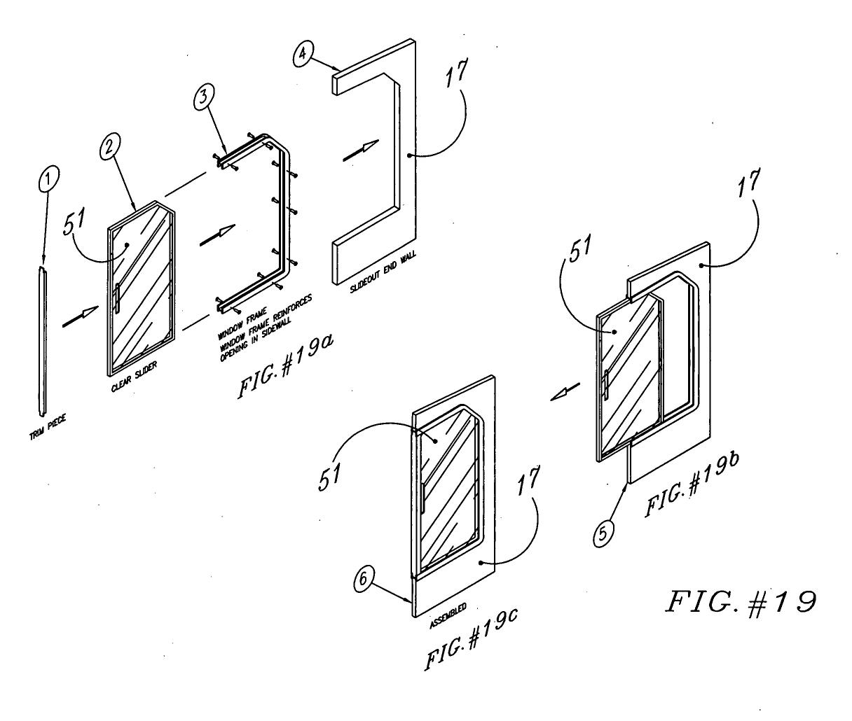

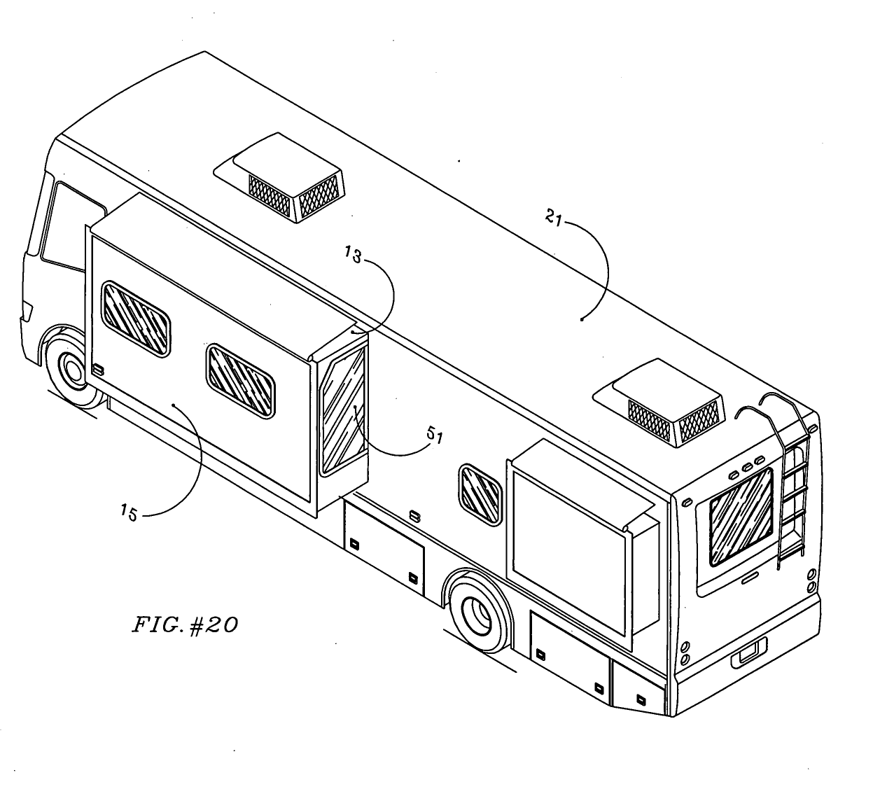

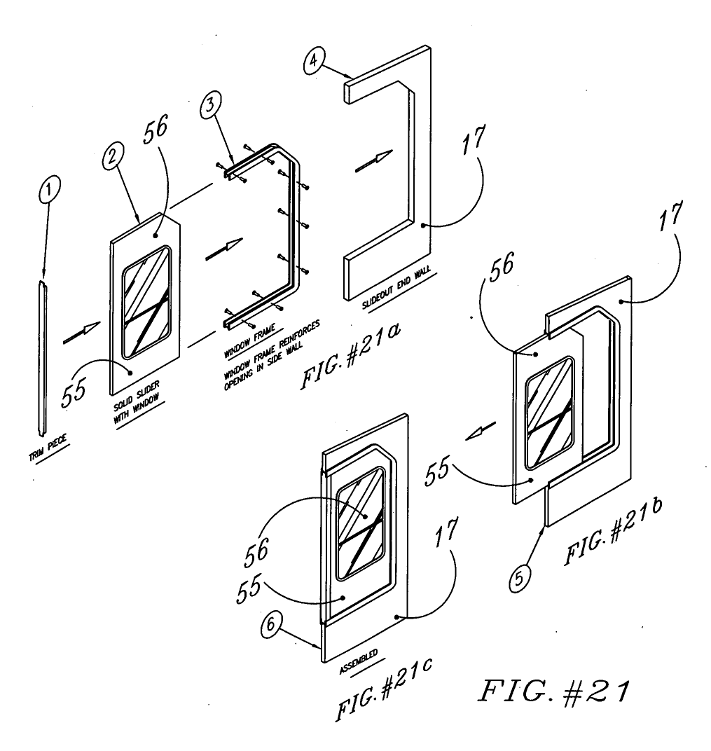

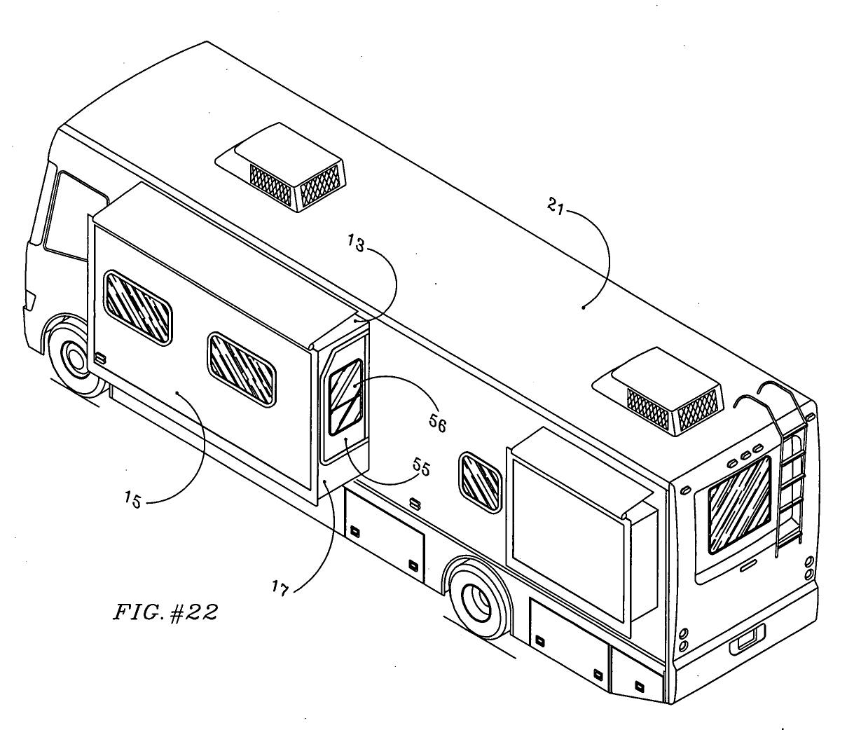

FIGS. 17a and 17b illustrate an embodiment where the end walls 17 and 19 have slide out glass panels 51 which can be stored under couch 27. FIG. 18 shows vehicle 43 with panels 51 removed and stored for travel. The removable glass panels 51 are shown in an exploded view 19a, where the components are assembled and inserted into end wall 17 and trim is added. FIGS. 19b and 19c show the glass panel being removed and fully installed. FIG. 20 shows the side of vehicle 43 with the glass panels 51 in place and the slide out room extended. In a variation of this embodiment, glass panels 51 are replaced with solid panels 55 that have a portion 56 of glass, as shown in detail in FIGS. 21a, 21b and 21c and in place extended in FIG. 22.

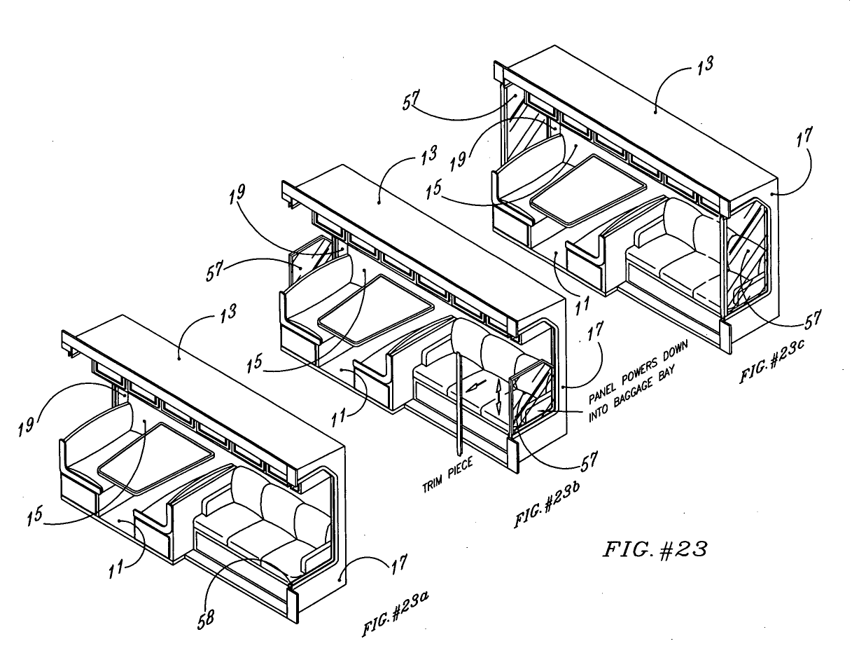

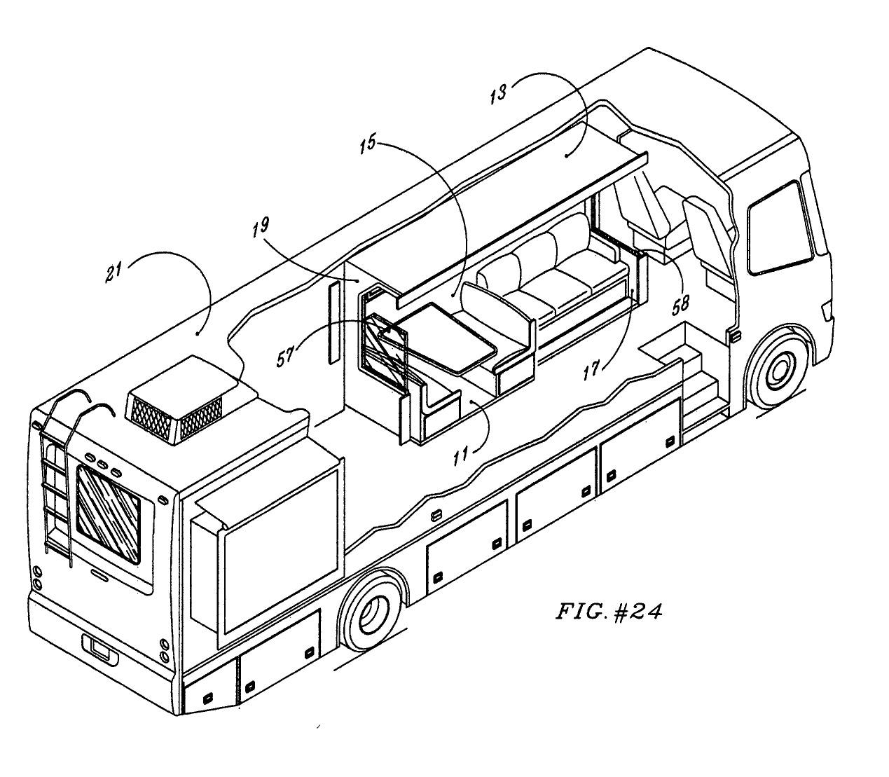

A final embodiment is shown in FIGS. 23a, 23b and 23c, where the end walls 17 include a powered clear panel 57 that function like power windows on an automobile, where the clear panel powers down via an electric or hydraulic motor into the end wall 17 or into the baggage compartment (not shown) of the structure below the inside floor down slot 58 in panel 17. The panel 57 can be partially up, as in FIG. 23b or fully up as in FIG. 23c. FIG. 24 illustrates glass panel 57 partially up in end wall 19 and stored via slot 58 in panel 17.

While particular embodiments of the present invention have been illustrated and described, it is not intended to limit the invention, except as defined by the following claims.

1. A slide out room device for use with vehicles and other structures having a movable room adapted to be extended when in use and retracted when not in use, comprising:
a slide out room defined by a floor, roof, main side wall, and first and second end walls mounted in position in a structure for extension and retraction of said slide out room as desired;
said first and second end walls being adapted to be moved to a second position when said slide out room is retracted in to eliminate at least some of the visual and physical obstruction said first and second end walls generate in their room defining position.

2. The device of claim 1, wherein at least a portion of said first and second end walls are removable when said slide out room is retracted.

3. The device of claim 2, wherein said slide out room further includes storage space for storing said first and second end wall sections after removal.

4. The device of claim 1, wherein at least a portion of said first and second end walls are adapted to roll up into said slide out room ceiling.

5. The device of claim 1, wherein at least a portion of said first and second end walls are adapted to roll down into said slide out room floor.

6. The device of claim 1, wherein at least a portion of said first and second end walls are adapted to roll back into said slide out room main side wall.

7. The device of claim 1, wherein at least a portion of said first and second end walls are adapted to slide into the remaining portion of said first and second end walls of said slide out room.

8. The device of claim 1, wherein at least a portion of said first and second end walls and at least a portion of said ceiling are adapted to telescope into said side walls and ceiling of said slide out room.

9. The device of claim 1, wherein at least a portion of said first and second end walls and at least a portion of said ceiling are formed of bellows adapted to slide into said side walls and ceiling of said slide out room.

10. The device of claim 1, wherein at least a portion of said first and second end walls are formed from removable clear panels.

11. The device of claim 10, wherein said removable clear panels further include a solid portion.

12. The device of claim 1, wherein at least a portion of said first and second end walls are adapted to slide to an area below said floor of said slide out room through a slot in said first and second end walls connected to said area below said floor.

13. A slide out room device for use with vehicles and other structures having a movable room adapted to be extended when in use and retracted when not in use, comprising:
a slide out room means for defining a floor, roof, main side wall, and first and second end walls mounted in position in a structure for extension and retraction of said slide out room as desired;
said first and second end walls being adapted to be moved to a second position when said slide out room is retracted in to eliminate at least some of the visual and physical obstruction said first and second end walls generate in their room defining position; and
storage space for storing said first and second end walls in said second position.

14. The device of claim 13, wherein said first and second end walls are removable when said slide out room is retracted, said first and second end walls being selected from solid end walls, clear end walls, and end walls having solid and clear portions.

15. The device of claim 13, wherein at least a portion of said first and second end walls are adapted to roll up into a portion of said slide out room selected from the ceiling, the floor and the main side wall of said slide out room.

16. The device of claim 13, wherein at least a portion of said first and second end walls are adapted to slide into the remaining portion of said first and second end walls of said slide out room.

17. The device of claim 16, wherein at least a portion of said ceiling is adapted to telescope into said ceiling of said slide out room.

18. The device of claim 13, wherein at least a portion of said first and second end walls and at least a portion of said ceiling are formed of bellows adapted to slide into said side walls and ceiling of said slide out room.

19. The device of claim 13, wherein at least a portion of said first and second end walls are adapted to slide to an area below said floor of said slide out room through a slot in said first and second end walls connected to said area below said floor.
